(19) United States
(12) Patent Application Publication
(10) Pub. No.: US 2020/0367535 A1
(43) Pub. Date: Nov. 26, 2020

(54) CONTINUOUS-FLOW TREATMENT SYSTEM FOR SOLID FOOD AND ANIMAL FEED AND OTHER BULK MATERIALS, HAVING A HEAT TREATMENT DEVICE FOR THERMAL CONTINUOUS-FLOW TREATMENT

(71) Applicants: Tatiana GUZUN, Compiegne (FR); Carlos Alberto Ramos DIOGO, Carcavelos (PT)

(72) Inventors: Tatiana GUZUN, Compiegne (FR); Carlos Alberto Ramos DIOGO, Carcavelos (PT)

(21) Appl. No.: 16/988,412

(22) Filed: Aug. 7, 2020

Related U.S. Application Data
(63) Continuation of application No. PCT/EP2019/053007, filed on Feb. 7, 2019.

(30) Foreign Application Priority Data
Feb. 7, 2018 (DE) 10 2018 102 700.1
Feb. 7, 2018 (DE) 10 2018 102 702.8

(51) Int. Cl. A23L 3/22; A23N 17/00

(52) U.S. Cl. CPC A23L 3/225; A23V 2300/24; A23N 17/004

(57) ABSTRACT

A continuous-flow treatment system having a heat treatment device for the thermal continuous-flow treatment of solid food and animal feed and other bulk materials, including: a tubular drum having a motor-driven shaft and a drum casing connected to same via spoke elements, wherein the drum is open at the end sides thereof; a screw conveyor attached to the inner side of the drum casing; a housing which can be closed on all sides, in which the drum is rotatably mounted, and which has at least a respective supply opening and discharge opening, wherein of the components forming the drum, at least the drum casing is completely surrounded by the housing; at least one temperature sensor arranged in the drum; and a heating device having a hot air generator and an air distributer with at least one wide-slot nozzle extending up to the drum casing.

This nonprovisional application is a continuation of International Application No. PCT/EP2019/053007, which was filed on Feb. 7, 2019, and which claims priority to German Patent Application No. 10 2018 102 700.1, which was filed in Germany on Feb. 7, 2018, and to German Patent Application No. 10 2018 102 702.8, which was filed in Germany on Feb. 7, 2018 and which are all herein incorporated by reference.

### BACKGROUND OF THE INVENTION

### Field of the Invention

The present invention relates to a continuous-flow treatment system for thermal continuous-flow treatment of solid foods and animal feeds and other bulk materials.

### Description of the Background Art

Foods and animal feeds, such as for example field crops, fruit, spices, herbs, cereals and dietary fibers, seeds or nuts must often be subjected to heat treatment, wherein there may be a variety of aims. One aim may lie in pasteurization in order to sterilize germ-laden foods and animal feeds and other bulk materials. For example, black pepper is germ-laden to a high degree. Another aim may lie in performing, on the one hand, drying with minimal losses of technical and functional characteristics and, on the other hand, roasting or toasting for the purposes of seeking new colors, flavors and/or textures, for example in the case of the roasting of coffee or cocoa.

The heat treatment is often performed in batches in closed containers. Here, it is duly possible for the process to be well-controlled, and further influences can be imparted, such as the application of a vacuum to the process container or the introduction of inert gas. However, the capacity in batchwise operation is limited and is therefore often uneconomical.

DE3344214A1 describes a device and a method for the thermal continuous-flow treatment of linseed. Here, all method stages, that is to say heat treatment and subsequent cooling, take place in different sections within the same drum. The drum is static, whilst a conveying screw in the interior of the drum rotates. There is thus the risk of germ-laden product fractions being carried over into the cooling stage if the heating phase was not long enough and the temperature was not high enough. The throughflow speed can be optimized neither for the heat treatment phase nor for the cooling phase, because the same conveying screw runs through both stages. If product defects arise, the entire content of the drum must be discarded, and thorough disinfection of the entire system must be performed.

DE 20 2008 011 577 U1 also presents a heat treatment device for the thermal treatment of solid foods, having a tubular roasting drum which is mounted rotatably in a housing which is closable on all sides and which completely encloses the drum casing. The heat treatment device is however configured for batchwise treatment, and does not allow continuous-flow treatment.

### SUMMARY OF THE INVENTION

It is therefore the object of the invention to be able to perform intensive heat treatment and to be able to control and monitor this more effectively.

In an exemplary embodiment, the heating of the product and the maintaining of the heat treatment temperature are performed as the product flows through the drum. The height of the fill can be influenced by means of the diameter of the drum and the height of the webs of the conveying screw attached to the inside. An advantage of the heat treatment device according to the invention is, for example, owing to the fixed connection of the webs of the conveying screw to the drum casing, the webs are jointly heated, and thus the contact area with the product is greatly enlarged.

Thus, in the case of the invention, the temperature control of the product is performed primarily by way of the contact of the product with the warmed drum, even if, optionally, steam or other gases such as hot air or ozone can additionally be blown into the drum in order to increase the efficiency of the targeted treatment, ensure thorough sterilization and/or influence the moisture content, the color etc. of the product during the course of the heat treatment phase, in particular if steam or other gases such as hot air or ozone are additionally blown into the drum, a special suction device adapted to each type of gas is additionally provided on the housing.

A feature of the invention, therefore, is the warming of the product by way of contact heat, and the manner in which the drum is warmed. According to the invention, the drum is warmed by hot air alone, which is blown onto the outer side of the drum casing. The air is however not simply blown into the intermediate space between drum outer side and housing wall, but is linearly fanned out by means of a wide-slotted nozzle which is directed in a very targeted manner onto a line on the drum. This line runs exactly where the product fill begins in the bottom region of the drum, or shortly before this location. This means that that drum wall section that has just been pre-warmed with a particular hot-air temperature immediately thereafter moves under the product fill owing to the rotation. Thus, the actual temperature acting on the product is already known very exactly through the preselection of the hot-air temperature. Heat losses are reduced in any case in the closed housing, but at any rate scarcely arise between the line of the warming at the outside and the start of the product fill.

In order to further improve the closed-loop control of the drum temperature, at least one temperature sensor provided in the drum casing may be provided, which temperature sensor is arranged in particular at the outflow-side end of the drum, because the product that has been conveyed to that point has, at the end, attained the temperature of the drum, and the drum temperature is thus at its highest there. Through closed-loop control of the hot-air temperature, it is firstly ensured that the temperature control of the product is performed to a sufficiently high level and for a sufficiently long time. Secondly, it permits a considerable energy saving, because there is no need to perform permanent overheating simply to ensure that the product quality is ensured. If it is ascertained by measurement that the temperature of the drum is high enough, the hot-air temperature and/or quantity is adjusted downward by closed-loop control. The advantage of the use of hot air for the purposes of drum heating also is that not only the temperature but also the air speed can be easily controlled in closed-loop fashion, such that the heat supply can be controlled in an effective manner. In contrast to warming by means of steam, the heating device can also serve for the temporary cooling of the drum, and it is possible to set a drum temperature of less than 100° C. without condensate forming.

The heat treatment device according to the invention can be refined to include at least five further temperature sensors which are arranged in the drum so as to be distributed over the length of the drum and which extend from the shaft into the intermediate space between shaft and drum casing. By means of the at least three, in particular five, temperature sensors, it is possible to record a temperature profile over the length of the drum, from which it is possible to derive whether the selected treatment temperature is attained and maintained for a sufficient length of time.

For this purpose, it is advantageous for the sensor carrier arms to be designed to be of such a length that the temperature sensors protrude into the product fill. For this purpose, an angle sensor on the shaft is additionally required. By means of the known angular position of the temperature sensors, it is firstly possible to accurately detect when these protrude into the product fill, such that the measured value then detected corresponds to the product temperature in the middle of the fill. Furthermore, by linking the temperature measurement to the angular position, the air temperature within the drum can be measured. This furthermore substantially corresponds to the surface temperature of the product fill. By means of a comparison of the two measured values, complete heating-through of the product fill can be inferred.

The heat treatment device can be advantageously supplemented by a conditioning device which, through highly effective and rapid cooling and moisture content setting in advance, makes it possible to perform intensive heat treatment and enable the product to be subjected to follow-up treatment in the continuous flow without buffer storage.

The drum casing can be cooled, such that cooling of the product is effected simply by the fact that it is conveyed through the drum by means of the conveying screw on the inner side of the drum casing and is in constant contact with the cooled drum casing. By means of lines arranged in the region of the outflow opening, a feed and return to the drive shaft of hollow design is created, at the end of which drive shaft there are in turn provided rotatable connections for producing a connection to an external pump circuit.

An other feature of the additional conditioning device is that the opening of the drum at one end side is free from drive elements. There are thus no rotating elements which support the drum casing. This makes it possible for at least one static fluid line which comprises multiple outlet elements to extend far into the interior space of the drum casing proceeding from the end side. The line thus projects far into the drum casing through the end side of the drum in an unhindered manner. Via the line, it is possible in particular for cold air to be introduced, which additionally cools the product lying on the cooled drum casing. Further conditioning can be performed by means of the humidity of the air that is fed in. If steam has been used during the preceding heat treatment, the humidity can be lowered again by means of a feed of dry air. Condensate that forms can be conducted out of the drum, for example by means of a slight inclination of the drum, and is then drained from the bottom of the housing. Rehumidification by means of humidified air or by injection of water via the fluid line is likewise possible.

In order to make the open inflow opening possible, the drum casing is, in the region of the end side, rotatably mounted preferably not by means of a shaft but rather directly by way of its outer circumference on roller bearings attached in the housing.

The open end side at the inflow opening furthermore makes it possible for the product to be conducted in a targeted manner as far as into the starting region of the conveying screw and, in the process, fanned out, in order to attain as areal as possible a distribution on the drum casing from the outset and thus improve the cooling. The product is thus preferably fed in via an inflow pipe which leads through the housing wall and which, in the interior, transitions into a chute which widens toward the end.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the main sections of a heat treatment device in a schematic side view;

FIG. 2 shows parts of a drum of a heat treatment device in a schematic perspective view;

FIG. 3 shows a part of the drum in the region of its infeed side;

FIG. 4 shows a polygonal drum;

FIG. 5 shows further details of the drum as per FIGS. 2 and 3;

FIG. 6 shows the drawing-in region of the drum mounted in a housing;

FIG. 7 shows the bearing arrangement of the drum on the discharge side;

FIG. 8 shows a detail of a shaft a short distance downstream of the drawing-in screw;

FIG. 9 shows the heat treatment device in with a heating device;

FIG. 10 shows an air distributor with wide-slotted nozzles;

FIG. 11 shows the heat treatment device in from the end side;

FIG. 12 shows the heating device in a perspective view;

FIG. 13 shows the interior of the electric heating device;

FIG. 14 shows a transfer device;

FIG. 15 shows a conditioning device from the outside;

FIG. 16 shows a conditioning drum of the conditioning device from the outflow side;

FIG. 17 shows the conditioning drum from the inflow side;

FIG. 18 shows the cooling device of the conditioning drum at the outflow side; and

FIG. 19 shows a perspective view of the entire heating device together with the heat treatment device.

### DETAILED DESCRIPTION

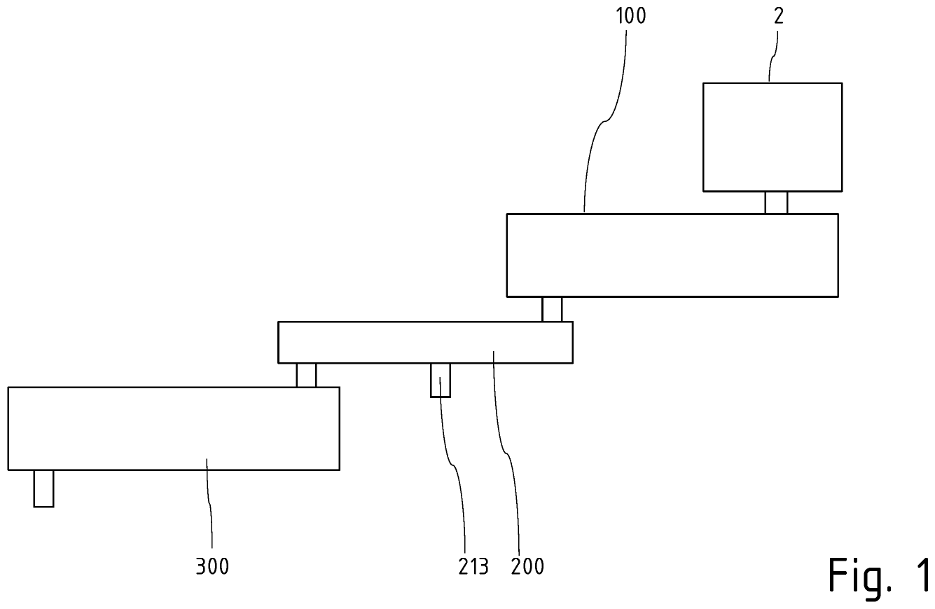

FIG. 1 shows a complete system with a heat treatment device 100, with a transfer device 200 and with a conditioning device 300. By means of a feed device which is not described in any more detail below, a pourable bulk material is fed into the heat treatment device 100 and is heat-treated therein as it flows through. Via the transfer device 200, the bulk material passes into the conditioning device 300, where it is cooled and possibly humidified. If a fault arises during the heat treatment, the product can be transferred out via the outflow opening, which can be opened and closed by means of actuating elements.

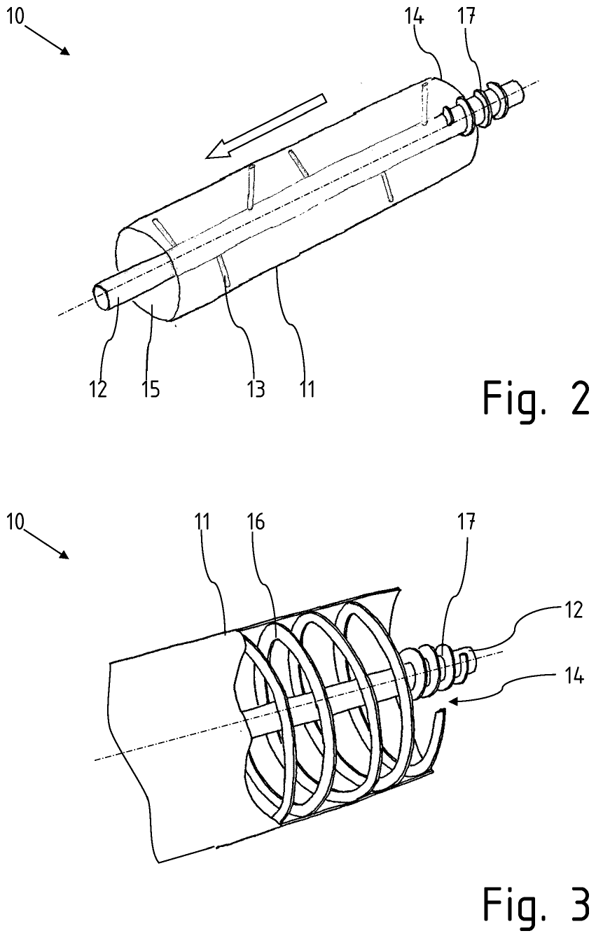

FIG. 2 shows parts of a drum 10 of the heat treatment device 100 in a schematic perspective view. A drum casing 11 is connected by means of multiple radially oriented spokes 13 to a shaft 12. The drum 10 has an open infeed opening 14 and an open discharge opening 15; the conveying direction in between is indicated by the block arrow. A drawing-in screw 17 is formed on the shaft 12 at the infeed opening 14.

FIG. 3 shows a part of the drum 10 in the region of its infeed opening 14. The drawing-in screw 17 on the shaft 12 extends as far as into that axial region of the shaft 12 which is surrounded by the drum casing 11. The drum casing 11 in turn has a conveying screw 16 on its inner side. The outer diameter of the drawing-in screw 17 and the inner diameter of the conveying screw 16 are coordinated with one another such that a relatively large radial free space is created.

The drum may be of cylindrical form. In particular, however, a drum 10′ of polygonal cross section is provided, as illustrated in FIG. 4 on the basis of the example of a drum 10′ with an octahedral drum casing 11′ and a conveying screw 16′ correspondingly adapted in terms of its shape to the drum casing 11′. The design of the type of the polygonal drum is defined on the basis of the product size or shape. For red paprika or chilli, a decagonal shape is advantageous; in the case of turmeric or vanilla sticks, an octagonal shape has proven successful. These specific geometrical shapes assist in particular in realizing a product-conserving mixing action.

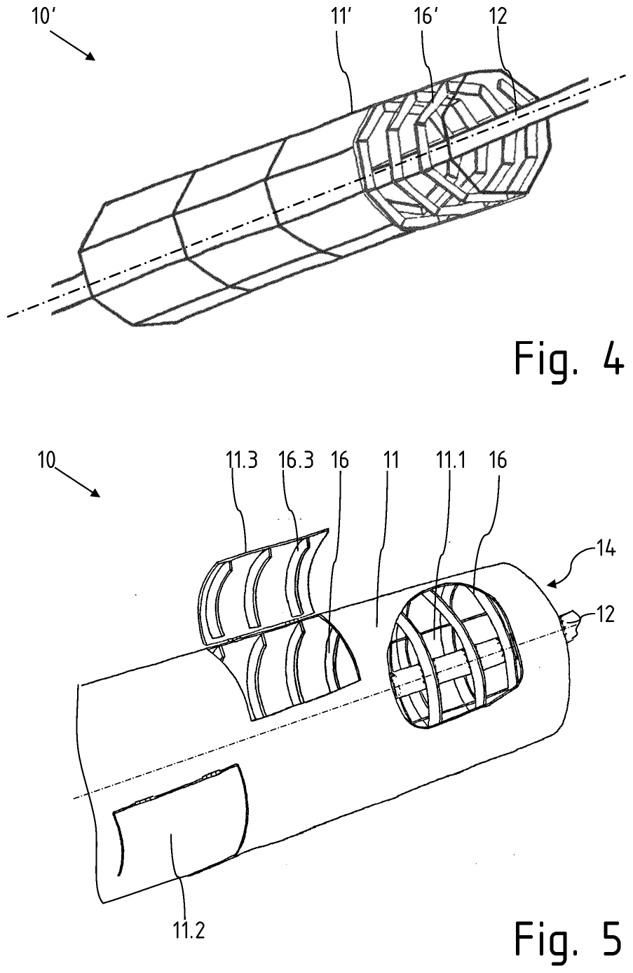

FIG. 5 shows further details of the drum 10. The drum casing 11 has multiple openings which are closable by means of flaps 11.1, 11.2, 11.3, such that, by opening the flaps 11.1, 11.2, 11.3, the interior of the drum 11 is made accessible in order to enable the interior of the drum 10 to be cleaned. For stability reasons, the flaps 11.1, 11.2, 11.3 are not lined up linearly along the shaft 12, but are arranged with an axial spacing to one another and at different angular positions on the drum casing 11. In order that, firstly, a freely accessible cross section is realized at the opening, but secondly also that the conveying screw 16 arranged on the inner wall of the drum casing 11 is not interrupted during operation, screw web segments 16.3 are arranged on the inner side of each flap. Thus, when the flaps 11.1, 11.2, 11.3 are closed, a continuous conveying screw 16 is again realized.

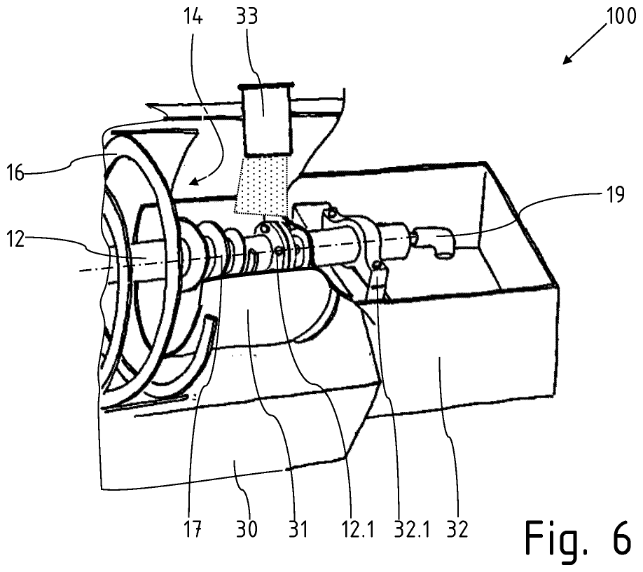

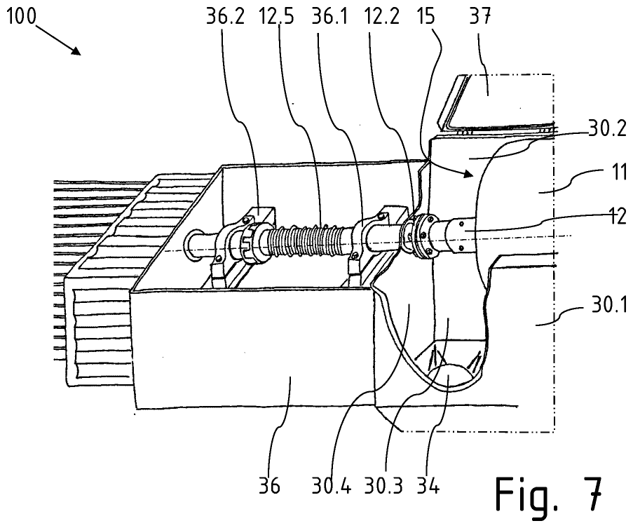

FIG. 6 illustrates the drawing-in region of the drum 10 mounted in a housing 30. The housing 30, which simultaneously forms the process chamber in which the product for sterilization is accommodated, surrounds the drum 10 completely during operation, wherein only the lower housing parts are illustrated in FIG. 6. The drum 10 is mounted with its shaft 12 in a shaft bearing 32.1. The shaft bearing 32.1 is situated in a bearing box 32 which is separate from the process chamber in order to prevent lubricant residues or abraded material from the shaft bearing 32.1 from entering the process chamber. Between the housing 30 and the bearing box 32, the shaft 12 is interrupted by a coupling 12.1 for the purposes of compensating alignment errors. Furthermore, the shaft is sealed off at its circumference between the coupling 12.1 and the shaft bearing 32.1 in order that no steam that is conducted into the process chamber, which steam is injected only via the nozzles into the high-temperature treatment drum, can escape there. The feed of the material takes place via an inflow pipe 33 which extends through the housing 30 into the interior and which ends a short distance above the drawing-in screw 17. A semicylindrical catching shell 31 is formed below the drawing-in screw 17 on the shaft 12. The catching shell 31 and the drawing-in screw 17 together have the effect that the fed product is moved axially in the direction of the drum 10 with its conveying screw 16. The product falls from the catching shell 31 directly into the infeed region of the drum 10 at the infeed opening 14.

The shaft 12 is internally hollow. The hollow space serves firstly for the lead through of sensor cables and secondly for the introduction of steam into the drum 10. In order to optimize particular treatment processes or optimize the moisture content of the product, steam can be fed into the hollow shaft 12 via a steam inlet line 19 which opens out within the bearing box 32.

FIG. 7 illustrates the bearing arrangement of the drum 10 on the discharge side 15. The shaft 12 is mounted at two shaft bearings 36.1, 36.2 in a further bearing box 36, which is separate from the housing 30 as process chamber, as is also the case on the infeed side. Of the housing, side walls 30.1, 30.2, a base 30.3 with a discharge opening 34, an end wall 30.4 with a leadthrough of the shaft 12 to the bearing box 36, and a pivotable cover 37 are shown here.

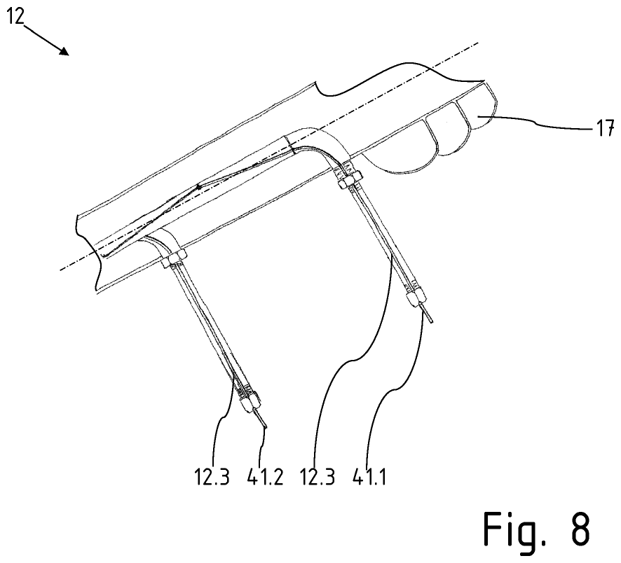

FIG. 8 shows a detail of the shaft 12 a short distance downstream of the drawing-in screw 17. In the shaft 12, which is formed as a hollow tube, there are arranged cable protection tubes in which sensor cables are led. Radial sensor carrier arms 12.3 are arranged on the shaft 12 at multiple axial positions, on the end of which sensor carrier arms there is arranged in each case one temperature sensor 41.1, 41.2. The sensor carrier arms 12.3 extend as far as into the radial intermediate space between the drawing-in screw 17 and conveying screw 16, in order to be able to measure the temperature as close as possible to the product conveyed between the turns of the conveying screw 16. Since the drum 10 does not rotate quickly, the product is not centrifuged over the entire inner circumference of the drum 10, but rather lies on the bottom of the drum 10 and is conveyed axially there.

Since the sensor carrier arms 12.3 are however arranged rigidly on the shaft 12 and the drum casing 11 is likewise connected by means of the spokes 13 (FIG. 1) to the shaft 12, a special effect arises during the temperature measurement: not only the measured values from the temperature sensors 41.1, 41.2 but also the angular position of the shaft 12 are fed to a closed-loop control device. As long as the sensor carrier arms 12.3 are situated at an angular position between 8 and 3 o'clock, no contact occurs with the product situated in the drum 11, and the temperature sensors 41.1, 41.2 are also not situated in the immediate vicinity above the bulk material. Thus, between approximately 8 o'clock and 3 o'clock, the temperature sensors detect the radiation heat of the heated drum casing 11, whereas, in the angle range between 3 o'clock and 8 o'clock, the temperature sensors are directly immersed in the bulk material and measure the temperature thereof by direct contact. By virtue of the temperature measurement values either being stored together with the present angular position upon the measurement or by virtue of the measurement only being performed at all at particular angular positions, it is possible to measure only the drum temperature of the externally heated drum 11, and/or the temperature of the bulk material being treated therein, using the same temperature sensors. Since it is furthermore the case that at least five temperature sensors 41.1, 41.2 are provided so as to be distributed axially over the length of the drum casing 11, it is possible for a temperature profile of the product in the drum 100 to be read off at any time. The measured drum temperature is recorded and controlled in closed-loop fashion. For the closed-loop control, a further sensor is provided at the end of the drum. By means of the closed-loop control, the drum temperature is directly set in relation to a heating device, such that current for heating is required only when necessary. Here, the electric heating permits a fast reaction of the heating device to the heating requirement in the drum. Furthermore, it is possible to determine whether the heating of the product in the drum 10 occurs quickly enough, and whether the temperature required for the successful heat treatment of the specific product is attained and maintained.

In order, in the drum 10, to measure temperatures influenced not only by heat conduction but also by convection, it is preferable for two further sensors to be integrated with a shorter length on the support arm 12. Their position is defined in relation to the heat distribution in different drum sizes or models.

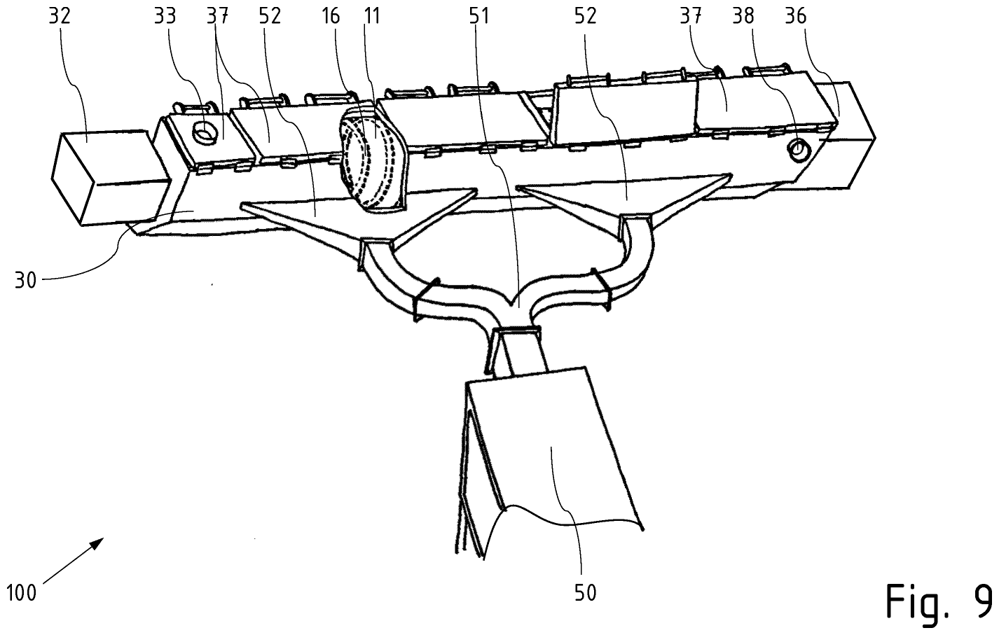

FIG. 9 shows the heat treatment device 100 with parts of a heating device 50. By means of a cutaway portion in the housing 30, a part of the drum casing 11 with the concealed conveying screw 16 situated on the inside is visible. The bearing boxes 32, 36 can be seen on the housing 30 at the right and at the left. The conveying direction is from left to right in FIG. 9. At the inflow opening 33, the product is fed in and then passes all the way to the right within the drum 10. The housing 30 is upwardly open and is closed off by means of multiple maintenance flaps 37. Here, the heating device 50 provides hot air which is distributed to multiple wide-slotted nozzles 52 by means of a hot-air distributor 51. The wide-slotted nozzles 52 extend axially along the housing and cover a major part of the length of the drum in the housing 30. Air can be drawn out of the housing 30 via an outlet opening 38.

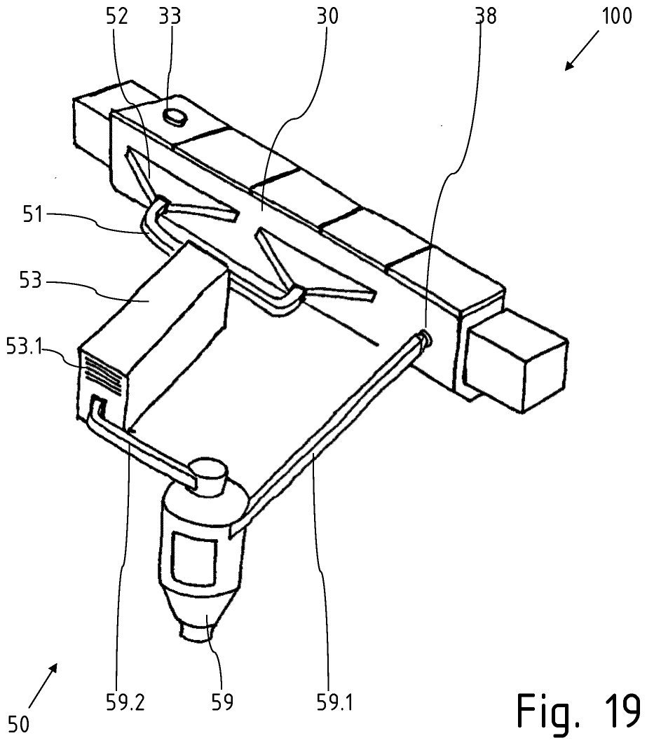

FIG. 19 shows the heat treatment device 100 with the entire heating device 50, which is arranged with its hot-air generator 53, the hot-air distributor 51 and the wide-slotted nozzles 52 in front of the housing 30 of the heat treatment device. An intake line 59.1 leads from the outlet opening 38 to a cyclone separator 59. The air drawn out of the housing interior, which constitutes the treatment chamber of the heat treatment device 100, has dust and condensate removed from it in the cyclone separator and is conducted via a further air line 59.2 to the hot-air generator 53. A closed circuit is thus realized, in which pre-warmed air is heated again and is fed into the process again, such that considerable energy savings can be attained. The housing of the hot-air generator 53 furthermore has housing openings which are openable and closable by means of flaps in a motor-driven manner. If fresh air is to be drawn in from the surroundings, in particular in order to lower the temperature in the process or in order to quickly cool the heat treatment device 100 for the purposes of maintenance and cleaning, the housing openings are opened. It is also possible for a slide which is movable in a motor-driven manner to be provided on the housing rear side of the hot-air generator 53, which slide moves away downward and, in opening up the slot-shaped openings, is simultaneously moved in front of the inlet of the air line 59.2 in order to shut off this air path.

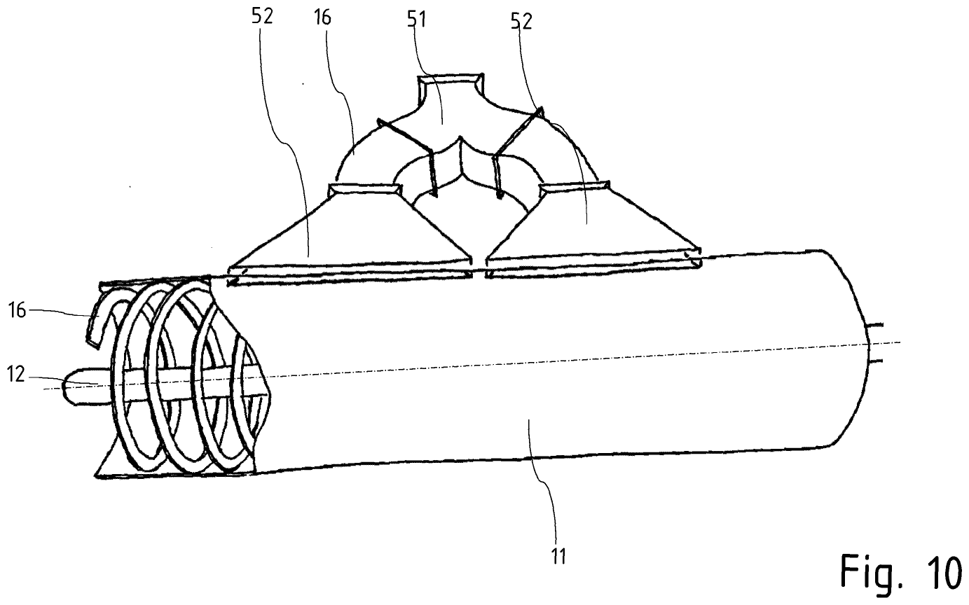

The illustration in FIG. 10 illustrates the air distributor 51 with the wide-slotted nozzles 52 without the housing, which wide-slotted nozzles extend directly as far as the outer side of the drum casing 11. That is to say, the wide-slotted nozzles 52 do not end at the housing (which is not illustrated here) but extend as far as housing openings, or even through housing openings into the interior of the housing.

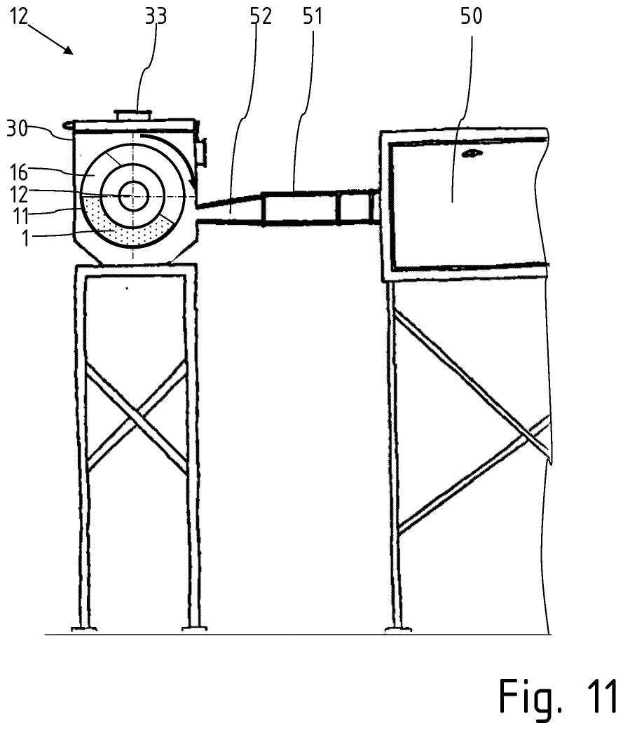

FIG. 11 shows a view of the heat treatment device 100 from the end side, wherein the housing 30 is shown in section. In the housing, the drum rotates in the direction marked by the arrow. In the chambers that are formed on the drum casing 11 between the webs of the conveying screw 16, the product is conveyed axially in a continuous manner. Owing to the direction of rotation, the position of the fill of the product 1 during operation is however not symmetrical in relation to a vertical central axis, with the fill cone rather having been pulled upward in the direction of rotation owing to the wall friction. The mouth of the wide-slotted nozzles 52 is now directed exactly toward that angle zone on the outer side of the rotating drum 10 which is at the edge of the fill of a product 1. The drum casing is thus heated exactly where—or a short distance before—the initial contact occurs between a sector of the drum casing 11 and the product 1 in the interior of the drum 10.

Thus, viewing the drum 10 from the discharge opening 15, as in FIG. 11, the wide-slotted nozzle 52 is arranged at a position between 2 and 4 o'clock in the case of a clockwise drum rotation, whereas the wide-slotted nozzle would be arranged at a position between 8 and 10 o'clock in the case of a counterclockwise rotation.

That sector of the drum casing 11 which is heated from the outside by means of the wide-slotted nozzle 52 thus, immediately after the heating, moves away under the product fill lying thereon, such that the heat can be released in a targeted manner to the product. The temperature control of the product 1 is thus possible with very high accuracy, specifically because no direct heating is performed by means of blown-in air, but rather only indirect heating is performed by heat conduction via the contact with the drum casing 11 and the webs of the conveying screw 16 fastened thereto and by heat radiation of the drum casing 11.

By means of the wide-slotted nozzles 52, owing to the invention, uncontrolled heating of the entire housing interior space is avoided, and only that small angle zone on the drum casing 11 which is situated immediately before the point of contact with the product is warmed in a targeted manner. For this purpose, it is also the case according to the invention that the heating is performed not in punctiform fashion but rather over a major part of the axial length of the drum casing 11, cf. FIGS. 9 and 10, specifically over more than half of the length of the drum casing, in particular over more than three quarters of the length.

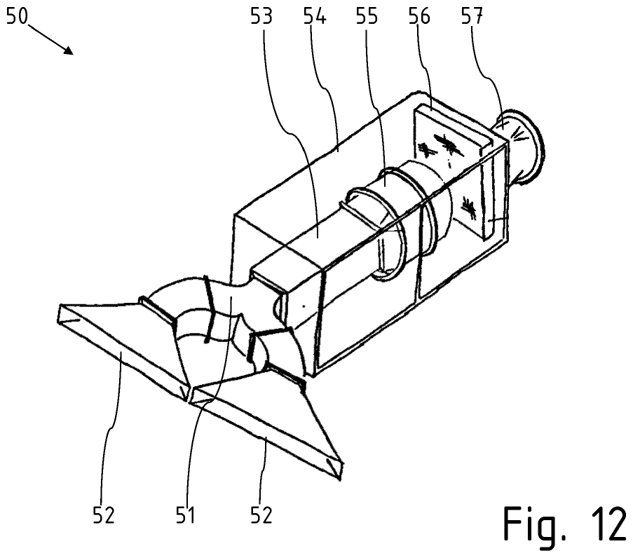

FIG. 12 illustrates the heating device 50 in a perspective view. By means of a fan 57, drawn-in air is blown through a filter 56 in a housing 56. The air flow 55 is conducted via a nozzle 55 into an electric hot-air generator 53, which forms a channel with a rectangular cross section. This in turn opens out at the outer side of the housing 54 and transitions into the hot-air distributor 51, via which the warmed air is conducted to the wide-slotted nozzles 52.

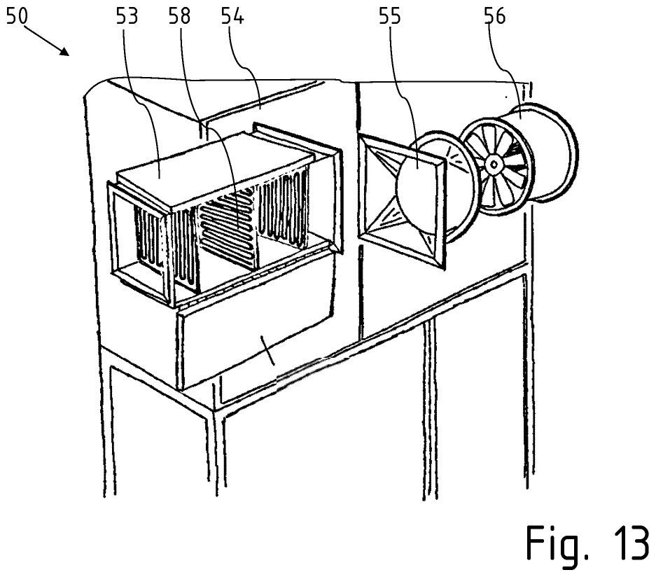

The interior of the electric hot-air generator 53 is shown clearly in FIG. 13, in which both the housing 54 and the heating device 53 itself are illustrated in open form. The hot-air generator 53 is composed of multiple plate-like ceramic heating elements 58, which comprise heating coils and through which flow can therefore pass. Through the use of electric heating elements 58, fast-reacting closed-loop control of the hot-air temperature in a manner dependent on the product and/or air temperature measured in the interior of the drum is possible.

The next treatment stage serves for the cooling and moisture conditioning of the product that has previously been heat-treated in the heat treatment device 100.

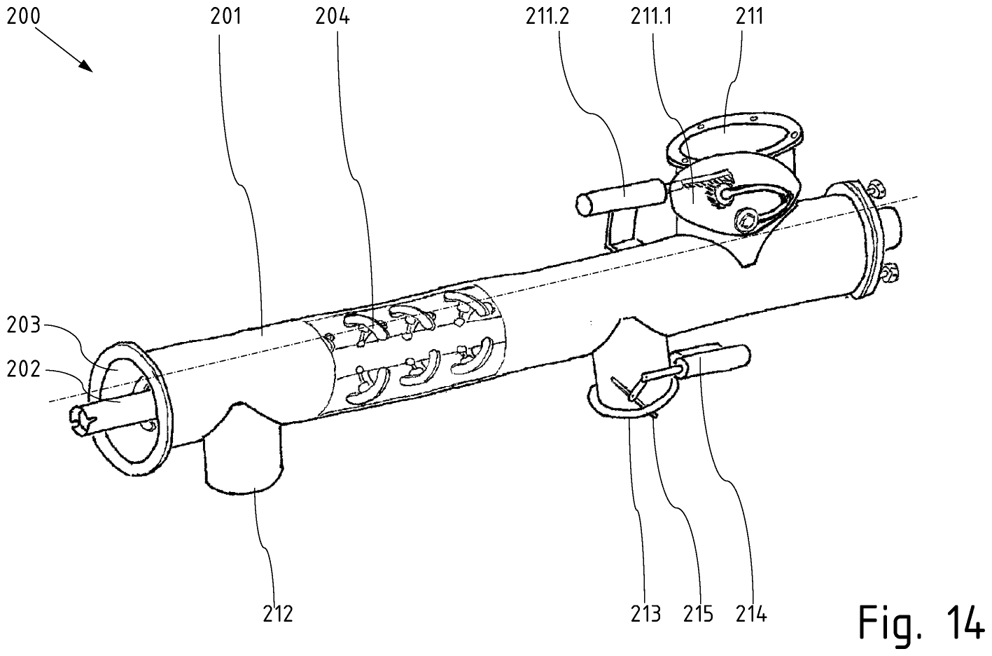

In one preferred embodiment of the invention, however, the product is not transferred directly into a conditioning device. There is preferably an interposed transfer device 200, which is illustrated in FIG. 14. The transfer device comprises a tubular housing 201 which, during operation, is arranged in a substantially horizontal position. In the interior space 203, there rotates a conveying screw 202, which is equipped with adjustable conveying elements 204. An inflow connector 211 is introduced into the housing 201 at the top side. The inflow funnel can be cleaned by means of a scraper 211.1 with drive 211.2. Blockages in the inflow connector 211 can thus be easily broken up. On the bottom side of the housing 201, there are provided two outflow openings 212, 213, of which the outflow opening 213 which is arranged closer to the inflow connector 211 can be closed by means of a drive 214 and a flap 215. The conveying direction predefined by the direction of rotation and design of the conveying screw 202 runs from the inflow connector 211 to the outflow opening 212, which is adjoined by the conditioning device.

For as long as the interior 203 of the housing 201 is filled with the product, the product itself prevents a gas exchange from being able to occur via the transfer device 200 between the heat treatment device 100, which directly adjoins the inflow connector 211, and the surroundings and/or the conditioning device adjoining the outflow opening 212. It is thus in particular not possible for any unfiltered ambient air to ingress into the heat treatment device 100.

During production operation, the parameters prevailing in the heat treatment device 100, such as temperature profile and dwell time, are continuously measured and compared with the setpoint values. In the event of deviations in the process as a result of which the product quality may be significantly impaired or even the correct decontamination of the product cannot be ensured, the possibly contaminated product is transferred out via the outflow opening 213. For this purpose, the flap 215 is simply opened. For as long as this is open, all of the product drawn in at the inflow connector 211 is transferred out through the outflow opening 213. Meanwhile, in the following section of the housing 201, that is to say between the outflow opening 213 and the outflow opening 212, the conveying screw is emptied. By means of a variation of the rotational speed of the conveying screw 202, a build up of the product is generated in the housing 201, such that, in turn, the exchange of air between the opened outflow opening 213 and the inflow connector 211 is prevented.

Only when the setpoint conditions are restored in the preceding process is the flap 215 closed again such that the product is conveyed across the closed outflow opening 213 to the outflow opening 212.

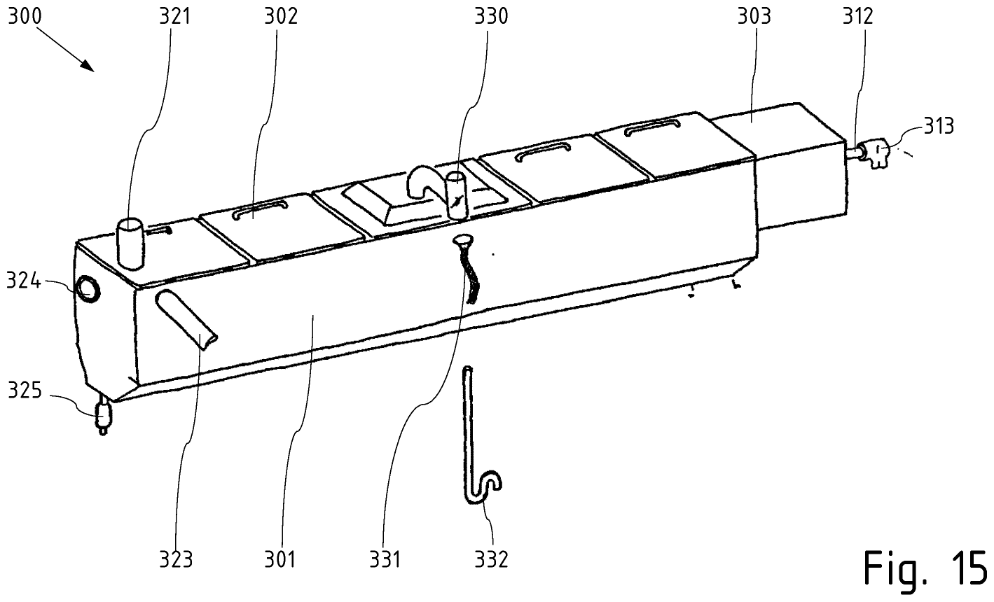

FIG. 15 shows a conditioning device 300 in a perspective view from the outside. The conditioning device comprises a housing 301 which is closable on all sides with respect to the surroundings. An inflow pipe 321 extends into the interior through the top side. The inflow pipe 321 is connected directly to the outflow opening 212 of the transfer device 200 (see FIG. 14), such that a transition which is closed off from the surroundings is realized. The interior space is easily accessible by means of maintenance flaps 302. An air line 323 likewise leads into the interior space of the housing 301. The outflow (not visible) is situated in the base region, on that side of the housing 301 which is situated on the right in FIG. 15. Furthermore, the right-hand housing side is adjoined by a bearing box 303, in which a drive motor may also be accommodated. A shaft 312 of a conditioning drum mounted in the interior of the housing extends through the bearing box 303 to the outside. The shaft is internally hollow, such that in each case one feed and one return line for a coolant circuit can be connected via an attachment connector 313 and a rotary coupling. An inspection glass 324 allows the product in the interior to be viewed. Condensed liquids can be drained via a valve 325. Attached to the top side is a T-piece 330 which is closable by means of a driven flap and which allows a targeted discharge of the exhaust air from the housing 301. The T-piece 330 is connected via a flexible connection 331 to a siphon 332, such that condensate that precipitates out of the exhaust air can be discharged, but without air being drawn in via the siphon.

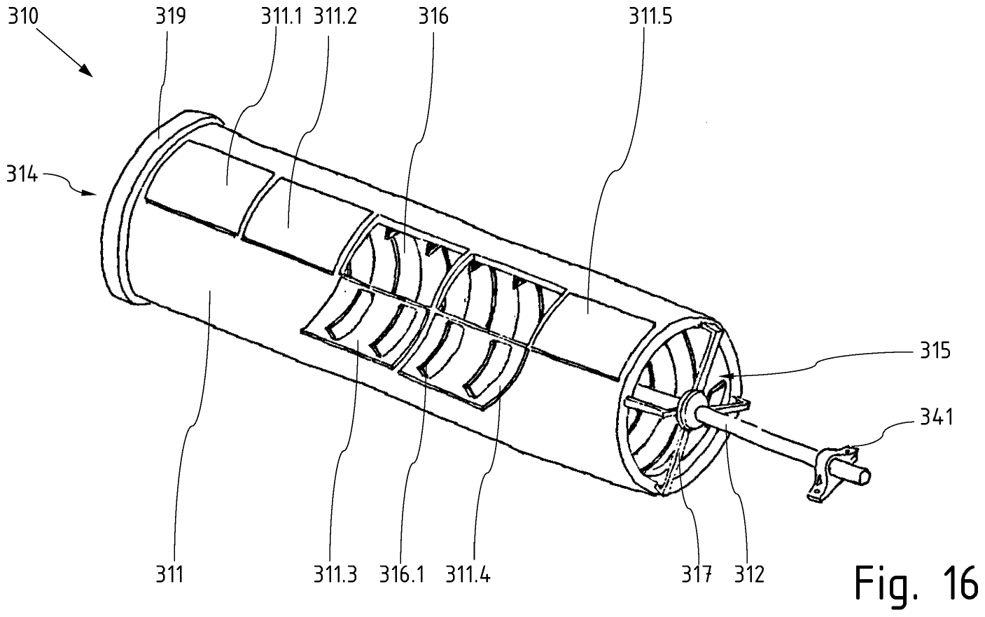

The conditioning drum 310 illustrated in a perspective view in FIG. 16, with a shaft 312 and a drum casing 311, forms the core part of the conditioning device 300. The conditioning drum 310 is open at both end sides. In FIG. 16, the viewing direction is directed toward an outflow opening 315. An inflow opening 314 is situated on the opposite side. As is also the case in the drum 11 of the heat treatment device 100, a conveying screw 316 is formed on the inner side of the drum casing 311. In order to be able to more easily clean the interior space while the conditioning drum 310 remains in the housing 301, the drum casing 311 has multiple maintenance flaps 311.1 . . . 311.5, which can be opened. In order that the conveying screw 316 does not need to be interrupted in the region of the maintenance flaps 311.1 . . . 311.5, screw segments 316.1 are attached to the inner side of the maintenance flaps 311.1 . . . 311.5. Below the outflow opening 315, in the base of the housing 301, there is provided an outflow opening from which the product is transferred out after having passed through the entire treatment process through the heat treatment device 100, the transfer device 200 and the conditioning device 300.

On the side of the outflow opening 315, the drum casing 311 is fastened to a spoke cross 317, from which the shaft 312 extends to a bearing 341. Thus, in the case of the conditioning device 300, the shaft 312 does not extend through the drum casing 311. On the side of the inflow opening, the drum casing 311 is reinforced at an end side by a bearing collar 319.

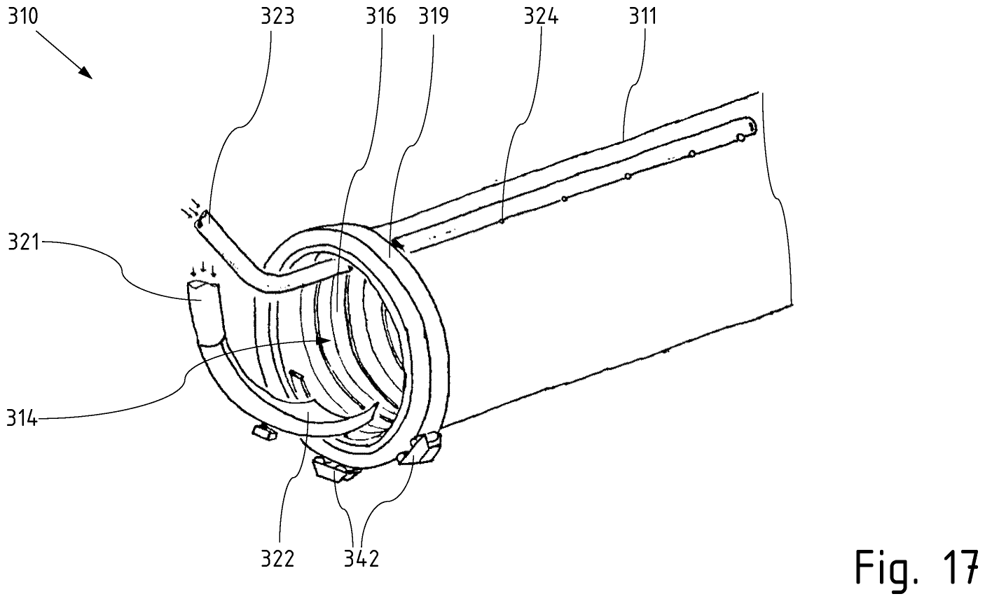

The significance of the bearing collar 319 can be seen from FIG. 17, which shows the inflow side of the conditioning drum 310 with the inflow opening 314. The bearing collar 319 is guided on roller bearings 342 which are attached to the base of the housing. The conditioning drum 310 can thus be mounted without a through-extending shaft, and consequently without spoke elements. This makes it possible for a static cold-air line 323 to be led into the interior of the conditioning drum 100, which cold-air line has multiple nozzles 324 over the length. The product conducted through the conditioning drum 310 by means of the conveying screw 316 can be rehumidified by means thereof.

The infeed of the product is performed via the inflow pipe 321, which leads through the housing wall and which, in the interior, transitions into a chute 322 which widens toward the end. The product thus passes into the region of action of the conveying screw 316.

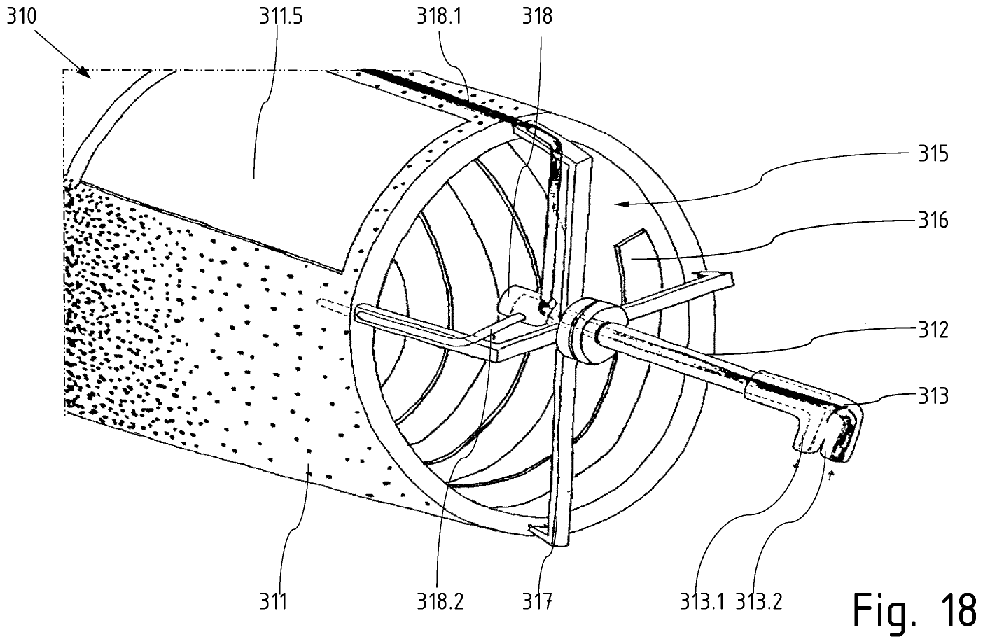

A major part of the conditioning device 300 is formed by the cooling of the drum 311, the functioning of which is illustrated in FIG. 18. The product conveyed through the conditioning drum 310 is present in a loose fill in the lower region of the conditioning drum 310 and is cooled by contact with the cooled surface of the drum casing 311 and of the webs, connected thereto, of the conveying screw 316, wherein the cooling action can be additionally enhanced by virtue of dry, cooled air being blown in. To cool the drum casing 311, water or some other coolant is introduced via a feed line attachment 313.1 on the attachment connector 313. The water or other coolant passes through a line in the cavity of the shaft 312 to a hub 318, and from there into at least one coolant line 318.1, which initially runs radially outward and then extends axially through the drum casing 311. The drum casing 311 is of double-walled form. The coolant runs out of the coolant line 318.1 into the cavity and displaces the coolant which is enclosed there and which has been warmed as a result of the indirect contact with the product, which coolant is then conducted out of the cavity via the coolant line 318.2 to the hub 318. From there, the coolant flows through the hollow shaft 312 to a return line attachment 313.1 on the attachment connector 313.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A continuous-flow treatment system for thermal continuous-flow treatment of solid foods and animal feeds and other bulk materials, having a heat treatment device, the system comprising:
a tubular drum with a motor-driven shaft and with a drum casing connected to the shaft via spoke elements, the drum being open at end sides;
a conveying screw attached to an inner side of the drum casing;
a housing closable on all sides and in which the drum is rotatably mounted and which has at least one inflow opening and one outflow opening, the drum casing being completely enclosable by the housing;
at least one temperature sensor arranged in the drum; and
a heating device with a hot-air generator and with an air distributor with at least one wide-slotted nozzle that extends as far as the drum casing.

2. The continuous-flow treatment system as claimed in claim 1, wherein the housing of the heat treatment device has at least two bearing leadthroughs for the shaft, and wherein at two housing sides that are provided with a bearing leadthrough, the housing is adjoined by one bearing box, of which at least one shaft bearing is arranged.

3. The continuous-flow treatment system as claimed in claim 2, wherein an end, which rotates in the bearing box of the shaft is equipped with at least two slip rings, the contact surfaces of which are connected to the temperature sensor.

4. The continuous-flow treatment system as claimed in claim 1, wherein a width of all wide-slotted nozzles amounts to more than half of the length of the drum casing.

5. The continuous-flow treatment system as claimed in claim 1, wherein the wide-slotted nozzle is directed onto an outer side of the drum casing where, at the inner side, the drum casing comes into contact, correspondingly to its direction of rotation, with product fill conducted in the conveying screw.

6. The continuous-flow treatment system as claimed in claim 1, wherein the shaft is, in a drawing-in region below the feed opening in the housing, at least partially surrounded by a catching shell or a catching tube which extends as far as into the drum casing, and wherein a drawing-in screw is formed on the shaft in the drawing-in region.

7. The continuous-flow treatment system as claimed in claim 1, wherein at least three radial sensor carrier arms are arranged on the shaft at multiple axial positions over the length of the drum casing, on an end of which sensor carrier arms there is arranged in each case one temperature sensor.

8. The continuous-flow treatment system as claimed in claim 7, wherein the sensor carrier arms extend as far as into the radial intermediate space between the drawing-in screw and the conveying screw.

9. The continuous-flow treatment system as claimed in claim 7, wherein the hot-air generator in the heating device is formed by at least one electrical heating element in the air channel and an upstream fan.

10. The continuous-flow treatment system as claimed in claim 1, further comprising an additional conditioning device for continuous-flow treatment after the heat treatment, at least comprising a housing which is closable on all sides and which has at least one inflow opening and one outflow opening and in which a tubular drum is rotatably mounted, wherein the drum is open at its two end sides and has a drum casing, on the inner side of which a conveying screw is formed,
wherein the opening of the drum at one end side is free from drive elements, and at least one static fluid line which comprises multiple outlet elements extends into the interior space of the drum casing proceeding from the end side,
wherein the drum is, at the other end side, connected by spoke elements to a shaft which is rotatably mounted,
wherein a coolant circuit is formed on the drum,
wherein the drum casing is hollow and/or has multiple coolant lines extending over the drum casing, and
wherein at least one feed and one return line are led through the shaft and via the spoke elements to the drum casing.

11. The continuous-flow treatment system as claimed in claim 10, wherein the shaft is mounted in a bearing box which is separate from the housing, in which the drum is accommodated, of the conditioning device.

12. The continuous-flow treatment system as claimed in claim 10, wherein the drum is, at an inflow opening, mounted in the housing by roller bearings, and, at an outflow opening, connected via the spoke elements to the shaft.

13. The continuous-flow treatment system as claimed in claim 10, wherein an inflow pipe leads through the housing wall, which inflow pipe extends as far as into the interior of the drum casing in the starting region of the conveying screw at the inflow opening.

14. The continuous-flow treatment system as claimed in claim 13, wherein the inflow pipe transitions into a chute which widens toward the end.
